(19) United States
(12) Patent Application Publication
(10) Pub. No.: US 2020/0058091 A1
(43) Pub. Date: Feb. 20, 2020

(54) ADDRESS MANAGEMENT SYSTEM

(71) Applicant: Oracle International Corporation, Redwood Shores, CA (US)

(72) Inventors: Noel Henry Edward Dcosta, Bangalore (IN); Sushmitha Sundar, Bangalore (IN); Manish Somani, Parker, CO (US)

(73) Assignee: Oracle International Corporation, Redwood Shores, CA (US)

(21) Appl. No.: 16/160,119

(22) Filed: Oct. 15, 2018

(30) Foreign Application Priority Data
Aug. 18, 2018 (IN) 201841030961

(51) Int. Cl. G06Q 50/26; G06Q 50/30; G06F 17/30; H04L 29/08; H04L 29/06

(52) U.S. Cl. CPC G06Q 50/265; G06Q 50/30; G06F 17/30206; H04L 67/306; H04L 63/102; G06F 17/30283

(57) ABSTRACT

The embodiments disclosed herein relate to an address management system that includes a registration service for receiving and validating address information for a user. Validation of a user's address information may involve consulting authoritative sources of information such as a governmental agency. Once validated, the registration service may issue and/or enable a user code that may be used as a key for retrieving the address information for the user. When a user requests a service from an application that requires an address, the user may supply the user code instead of an address. The application may retrieve from an address server at least a portion of the address associated with the registered user code.

### TECHNICAL FIELD

The present disclosure relates to sharing and controlling a user's address information. Specifically, the disclosure is directed to allowing users to share a code that represents their physical address, rather than disclosing the physical address itself.

### BACKGROUND

When a user interacts with an application to request a service or place an order, such as the delivery of goods or services to a particular location, the user is often required to supply identification and address information including a name, complete mailing (and/or delivery) address, and one or more phone numbers in order to access the service. Some applications require a user to have an account in which the identification information is stored in a user profile. When the user logs into their account and orders a product to be shipped to the user's residence, the application may use the address information in the user's profile to determine where to deliver the order. Other applications may require the user to supply a delivery address with each request for service. Submitting and re-submitting address information may be a time-consuming, inefficient, and error-prone process.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 is a block diagram that illustrates components of an address management system, in accordance with one or more embodiments;

FIG. 2 is a flow diagram that illustrates associating a user code with an authenticated address, in accordance with one or more embodiments;

FIG. 3 is a flow diagram that illustrates a user requesting service from an application that requires a physical address to fulfill, in accordance with one or more embodiments;

FIG. 4 is a flow diagram that illustrates sending the user's physical address to an application that provides service to the user, in accordance with one or more embodiments;

FIG. 5 is a block diagram showing the ordered interactions among components in the address management system, in accordance with one or more embodiments;

FIG. 6 is a block diagram that illustrates an address repository implemented as a peer-to-peer distributed ledger network, in accordance with one or more embodiments;

FIG. 7 is a block diagram that illustrates an address registration engine interacting with one of the peers of a peer-to-peer distributed ledger network, in accordance with one or more embodiments;

FIG. 8 illustrates cooperating distributed ledger networks, in accordance with one or more embodiments;

FIG. 9 shows a block diagram that illustrates a computer system, in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### 1. GENERAL OVERVIEW

Some embodiments include an address management system for managing users' addresses. The term “address” is used herein to refer to any type of address information for a user. An address may correspond to an address including, but not limited to a street address, a set of directions from a well-known point of interest, or map coordinates. An address may refer to a contact address such as an email address, an application-specific handle, a messenger address, or a phone number. Examples referring to one type of address may be equally applicable to other types of addresses.

The address management system is implemented separately from third-party applications that require the users' physical addresses to complete one or more functions (for example, a purchase of goods or services). Maintaining the users' physical addresses separately from the third-party applications may allow for updating a single system, i.e., the address management system instead of updating each of the third-party applications. Accordingly, the address management system may maintain a current address for a user in association with the user's user code. Furthermore, the address management system adds a layer of security by executing an authorization process to confirm that a requesting third-party application is authorized to access a user's physical address (or portion thereof). The address management system transmits the user's address to the requesting third-party application upon successfully validating the requesting third-party application's access permissions.

The address management system is further configured to validate a users' address. As an example, validation may involve consulting authoritative sources of information such as a governmental agency. Once validated, the address may be stored in association with a user code corresponding to the user. Embodiments described herein are directed to third-party applications receiving the user code from a user instead of receiving address information from the user. Third-party applications forward the user code to the address management system in a request for the user's address (or portion thereof).

This Specification may include, and the claims may recite, some embodiments beyond those that are described in this General Overview section.

### 2. ADDRESS MANAGEMENT ARCHITECTURE

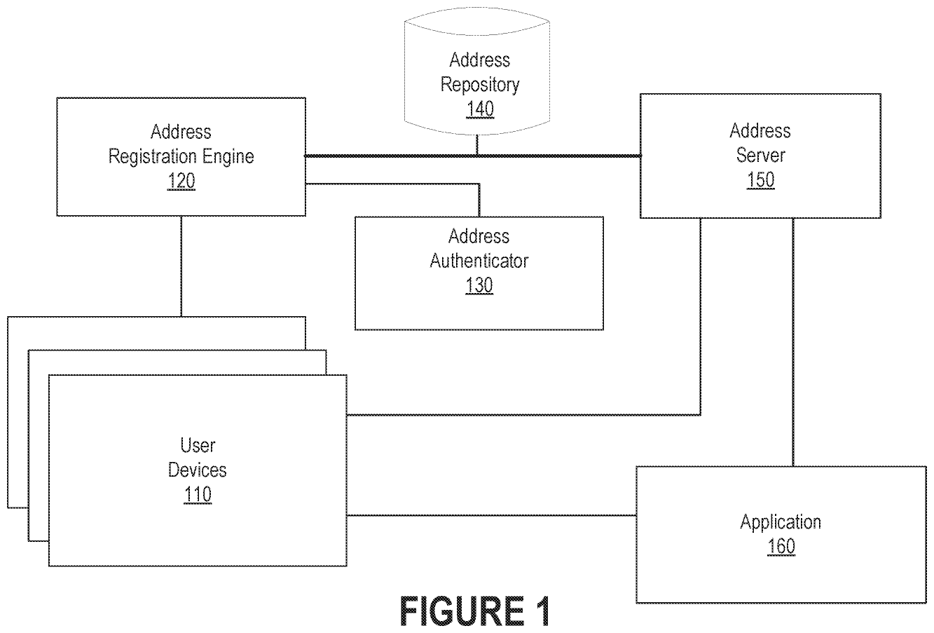

FIG. 1 is a block diagram that illustrates components of an address management architecture, in accordance with one or more embodiments. Components may be added, removed, modified, or combined. Functionality described in relation to one component may instead be implemented by another component. Accordingly, the specific components illustrated and/or described herein should not be construed as limiting the scope of any of the claims.

The system comprises User Devices 110, Address Registration Engine 120, Address Authenticator 130, Address Repository 140, Address Server 150, and Application 160.

User Device 110 is a device such as a mobile phone, tablet, laptop, or other computer used by a user to interact with address registration engine 120, application 160, and address server 150. Different user devices may be used to interact with each of the components of the address management system. For example, a user may (a) use a laptop or desktop computer to register an address with address registration engine 120 (b) use a tablet to order goods from application 160 to be delivered to their residence, and (c) use a mobile phone to respond to the address server's request to authorize the application to retrieve the delivery address.

Address Registration Engine 120 receives an address from a user and stores the address in association with a user code in address repository 140. The address may include a user's mobile telephone number, full physical address, email address, and map coordinates (which may be specified by dropping a pin on a map). In an embodiment, the map coordinates may be GPS coordinates. The user may choose their user code and send the user code, along with the address, to the address registration engine. Alternatively, the address registration engine may create a unique user code and return the unique user code to the user with a confirmation that the address was validated and successfully stored. Before storing the association between the user code and the address, the address registration engine may send portions of the address to one or more address authenticators 130 to validate that the respective portions of the address are valid and associated with the user.

Address Authenticator 130 comprises one or more authoritative sources of user and/or address information. Examples of authoritative sources of portions of user information may include a government agency such as a county registrar, department of motor vehicles, or voter registration, a credit bureau, a utility company, a bank, a published telephone directory, etc. can be used to verify that a user is known to be associated with the address provided. For this purpose, the user may provide additional information for validation purposes such as an ID number (such as a social security number), a telephone number, a bank account number, or a lot number for the physical property at the address.

In an embodiment, the additional information may be sent to the address registration engine along with the address. The address registration engine may pass the information to one or more address authenticators. The address authenticator may contact the user directly to obtain the additional information needed to validate the association of the address with the user. Address authenticator 130 may be fully automated, and not require any communication with the user.

Address Repository 140 may maintain an association between the user code and the user's address. The address registration engine may also subsequently update the user code or the address. In an embodiment, address repository 140 may comprise storage that is directly accessible to the address registration engine. Address server 150 may maintain the repository, and the address registration engine may send a new or updated address record to address server 150. Address repository 140 may be accessed through requests to a storage management system. An address record may be stored in the address repository in JSON or XML format for easy processing.

In one or more embodiments, address repository is any type of storage unit and/or device (e.g., a file system, database, collection of tables, or any other storage mechanism) for storing data. Further, the address repository may include multiple different storage units and/or devices. The multiple different storage units and/or devices may or may not be of the same type or located at the same physical site. The address repository may be implemented, or may execute on, the same computing system as the address registration engine and/or the address server. Alternatively or additionally, the address repository may be implemented or executed on a computing system separate from the computing systems on which the address registration engine and/or the address server are executed.

Application 160 is an application that provides a user interface through which a user requests goods or services to be delivered to the user at a particular address. In an embodiment, the user may interact with the application over the Internet, and a web browser may provide the user interface. In an embodiment, the application may run on a user device and provide an application-specific user interface. In an embodiment, the user may have an account set up with an application. The account may include a user profile for storing user information used for authentication, specifying preferences, payment options, and/or delivery address information. For example, a user may set up an account with an application through which the user frequently places orders. The user may supply the user code, instead of address information, to be stored in the user profile. Thereafter, each time an order is placed by the user, the user need not supply address information. Instead, the application may retrieve the user's address information from the address server using the user code stored in the profile. By retrieving the address each time that the address is needed to fulfill an order rather than caching the address locally, the application may always receive the most current address information. The user need not update profile information in every individual application to which the user has previously provided an address.

In an embodiment, the user places an order with an application with which the user has no account. An example may involve the user trying out a new pizza delivery service. The user may supply the user code instead of the physical address at the time the pizza is ordered. Neither the physical address nor the user code is necessarily stored for future use.

Address server 150 receives requests from applications that provide user services that require a physical address to fulfill, such as shipping goods, delivering food, or dispatching a repair person or contractor to the physical address. The address server may receive a user code with the application's request to obtain the physical address associated with the user code. The address server may allow the user to authorize the application to obtain the user's physical address for the purpose of fulfilling a specific user order. Even if the user provided the user code to the application, the user may deny access to any particular use of the user code.

If the user authorizes the application to obtain the physical address, then the address server sends the user's physical address information to the application. The address server may send all of the address information (referred to herein as the entire address) to the application. Alternatively, the address server may send only a portion of the address information. A portion of the address information is sent, instead of the entire address, if the portion is specifically requested or if the requesting application is only authorized to access the portion of the address.

In an embodiment, address server 150 may receive a verification request from the application. The verification request may include sending all or a portion of a user's physical address information along with the corresponding user code, and the address server may validate that the address information sent with the verification request is consistent with the address information stored in the address repository. Thus, the response to the verification request may be a binary indicator of whether or not the physical address information is valid.

### 3. PROCESS DESCRIPTION

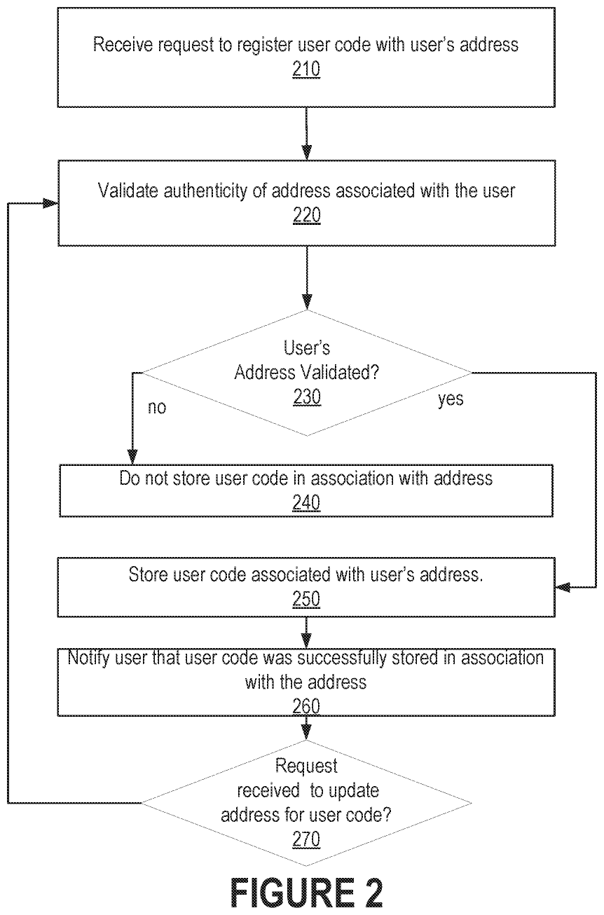

FIGS. 2, 3, 4, and 5 illustrate the overall address management system processes. Operations and components may be added, removed, modified, or combined. Functionality described in relation to one operation or component may instead be implemented by another operation or component. Accordingly, the specific operations and components illustrated and/or described herein should not be construed as limiting the scope of any of the claims.

FIG. 2 is a flow diagram that illustrates associating a user code with an authenticated address, in accordance with one or more embodiments. As described above, any other type of address may be equally applicable to examples reciting a specific type of address such as an address.

In Operation 210, address registration engine 120 may receive from user device 110 a request to register a user code associated with an address. The request includes at least the physical address. The registration request may also include a user code of the user's choice. If the request includes a user-selected user code, the address registration engine may verify the selected user code's uniqueness among other user codes that are stored within the address repository. For example, a universal (global) address service may require that the user code be globally unique. A country address service may only require that the user code be unique among user codes associated with physical addresses located within the country. If no user code is supplied, the address registration engine may construct a user code that is unique among the user codes stored in the address repository and may send the newly constructed user code back to the user. In an embodiment, the address registration engine may contact the user through the user device to receive from the user a new or different user code. The user may be prompted to approve a generated user code or select among a list of generated user codes. For example, the user may be prompted to enter a new user code whenever the user enters a code that is not unique. As another example, the address registration engine may construct several alternative unique user codes, and the user may select one. In an embodiment, the address registration engine may modify a user's provided user code to ensure uniqueness of the user code, such as by adding numbers or other characters.

In Operation 220, the address registration engine may validate that the physical address supplied by the user is known to be associated with the user. The user's request may also include images of authenticating documents such as an image of a birth certificate, passport, property tax bill, utility bill, etc. that includes the user's name and some combination of physical address, phone number, and/or other user identification such as a social security number or tax identification number. Such authenticating documents provide evidence that the user lives at or has personal or professional business at that physical address. The address registration engine may contact address authenticator 130 to validate the user's physical address based on some combination of the authenticating documents.

Operation 230 tests whether the address authenticator(s) successfully validated that the physical address is associated with the user. If not validated, then in Operation 240, the user code may not be stored in association with the address. If the address is validated, then in Operation 250 the validated address may be stored in association with the user code in address repository 140. In Operation 260 the user may be notified that the user code was successfully stored in association with the address. The notification to the user may include the user code supplied with the request, the user code supplied with the request modified by the address registration engine, or a new user code generated by the address registration engine.

In Operation 270, the address registration engine waits to receive further requests. The address registration engine may also receive requests to modify a user's address or a user code already stored in association with the user. Upon receiving a request to modify information already stored, the address information may be retrieved from the repository, and the new information may be validated.

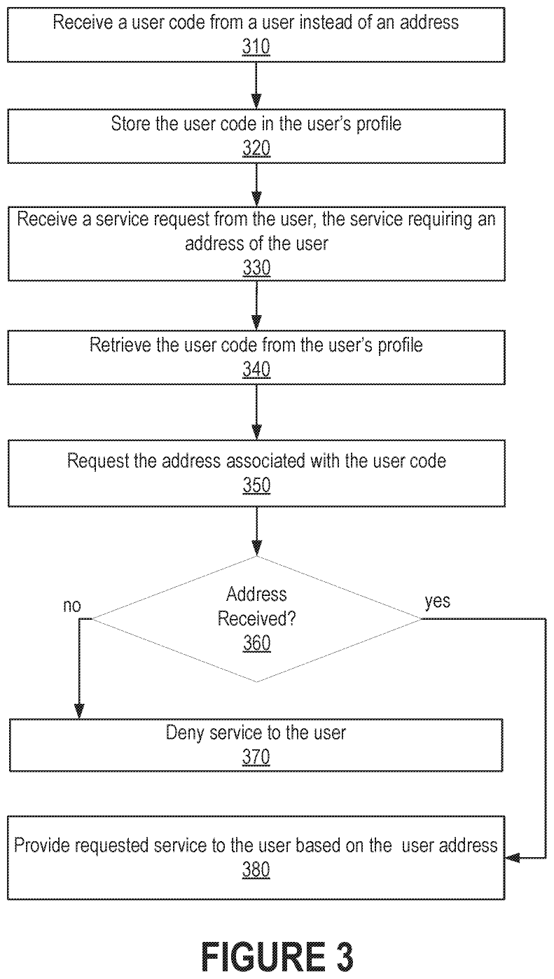

FIG. 3 is a flow diagram that illustrates a user requesting service from an application that requires a physical address to fulfill, in accordance with one or more embodiments. In an embodiment, the user may have an account with application 160. User information provided to the application may be stored in a profile. In Operation 310, the user supplies a user code that the application stores in the user profile instead of storing a physical street address and/or phone number.

In an embodiment illustrated by this flow, the application stores the user code and not the address information in the user profile (Operation 320). Thus, the application need not retrieve the address upon storing the user code in the profile. The application may only retrieve the address when the user requests a specific service from the application that requires some portion of the address. Upon retrieving the address from the address server, the application may use the address to fulfill the immediate order and may not cache the address in the user profile. If the address information changes in the future, the updated information will automatically be supplied when resolving the user code.

In an embodiment, the application may use the user code to resolve the address at the time of account setup. The physical address obtained from the address server may be stored in the profile instead of the user code. However, if the physical address information changes in the future, the user may have to log into the account and manually update the address information stored in the profile.

After the user profile is setup, the user may request a service from the application (Operation 330). The requested service may require physical address information to provide the service. In Operation 340, the application may retrieve the user code from the user's profile and in Operation 350, send the user code to the address server to obtain the portions of the physical address needed to provide the service to the user.

In Operation 360, if the application receives the requested portions of the user's physical address, then in Operation 380, the application uses the physical address information to deliver the service to the user. Otherwise, in Operation 370, the application rejects the user's service request.

In an embodiment, the application may be a composition of distinct services. For instance, an application may have an order entry component that interacts with the user to construct a purchase order. The order entry component may calculate the total cost of the order and receive payment information. However, another component of the application may handle order fulfillment and shipping. In an embodiment in which the total cost for the purchase order does not depend on the location to which an item is being shipped, the order entry component need not require the address. For example, the shipping charges may not depend on the destination address when free shipping is offered or when a standard shipping rate is used that does not depend on the delivery destination. Similarly, even when the order receiving component needs to compute shipping charges to solicit payment from the user, the zip code may be sufficient for computing the charges, and the entire address may not be required. The shipping service may resolve the user code to a shipping address, but not be authorized to access other user profile information.

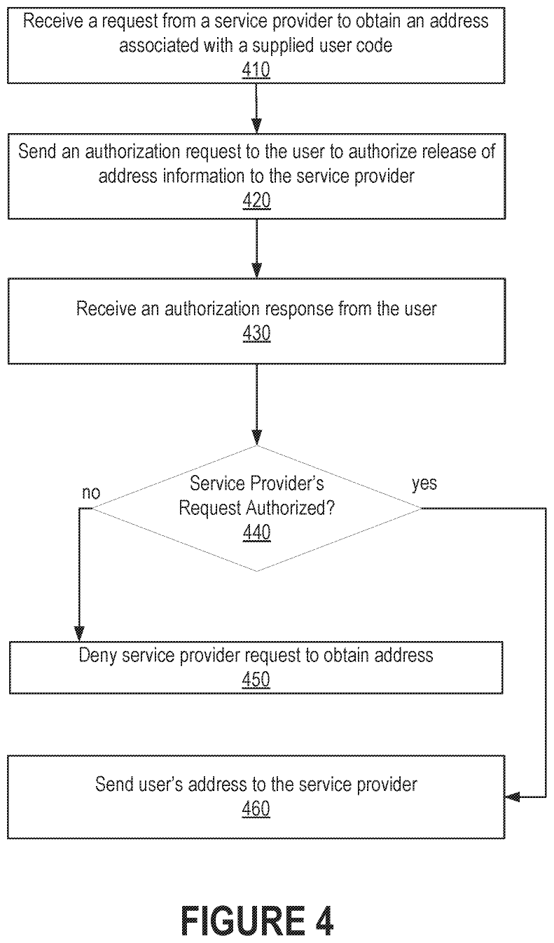

FIG. 4 is a flow diagram that illustrates sending the user's address to an application that provides service to the user, in accordance with one or more embodiments. In Operation 410, address server 150 receives a request from application 160 to receive address information associated with a user's user code. The application may request a certain portion of the address information such as a telephone number or city/state, or the request may ask for the entire address (that is, all information in the address record).

In an embodiment, authorizing the application to receive address information may comprise (a) authenticating the application itself or (b) authenticating possession of the user code. In an embodiment, the address server 150 may authenticate application 160 before continuing to process the request. A person of ordinary skill in the art will appreciate that any means of mutual authentication between two entities may be used to establish trust between the application and the address server such as prior registration of the application with the server and two factor authentication or public/private key encryption protocols. In an embodiment, authorizing the application to receive address information may comprise authenticating the user code. Authenticating the user code ensures that the application received the user code from the user that the user code is not counterfeit and not forwarded from an outside entity without the user's permission. For example, in an embodiment in which the application will retreive the address soon after receiving the user code, an additional dynamically-changing alpha-numeric code may be sent with the user code to establish authenticity to the address server. Before the user provides the user code to the application, the user may request a temporary alpha-numeric code that expires after a short period of time, such as after a few minutes. The application may send the alpha-numeric code along with the user code to the address server to demonstrate that the application received the user code from the user.

However, any means of authenticating data may be used for the purpose of determining that the user code is associated with the user and/or that the application received the user code from the user and not from some other source.

In Operation 420, the address server may contact the user through user device 110 to obtain authorization for the application to receive the requested portions of the address. In Operation 430, address server may receive a response from the user, via the user device, that grants or denies authorization to provide address information to the application. Even though the user may have provided the application with the user code, there may be several reasons why the user may not grant authorization. For example, the user may not have requested service from that application at that time, or the application may have requested more information than is needed to fulfill the user's service request. In an embodiment, the user may authorize a certain portion of the address information that may be different from the portions of the address information that were requested.

In Operation 440, if the user denies authorization, then the application's request to the address server may be rejected in Operation 450. If the user grants authorization, then the address server may send the authorized portion of the address information to the application in Operation 460.

### 4. EXAMPLES

Use of a user code to represent a user's address may be a human friendly way to eliminate the need to manually enter a full address every time the user registers to a new application or website. The address validation process may identify errors, such as typographical errors or a misremembered zip code, in the address supplied by the user. Storing exact location map coordinates provides a more precise input to a navigation application, resulting in better navigation instructions.

An example address may include:

KIM CRUISE

NO. 17, DENVER ELKS LODGE

2475 WEST 26TH AVENUE

DENVER, COLORADO 80211

USA

Mobile: +12607601234

Email: kimcruise@ gmail.com

Coordinates: (39° 44′27.6″N, 104° 59′31.0″W)

An example template for a user code representing an address may include: <userid>@ <jurisdiction> where the jurisdiction represents the region over which the userid is unique such as a city, state, country, or region. Example user codes for Kim Cruise of this form may be kimcruise01@ denver or kimcruise01@ colorado. Alternatively, a user code may be an autogenerated unique identifier such as 938172635467348 or Kimcruise789.

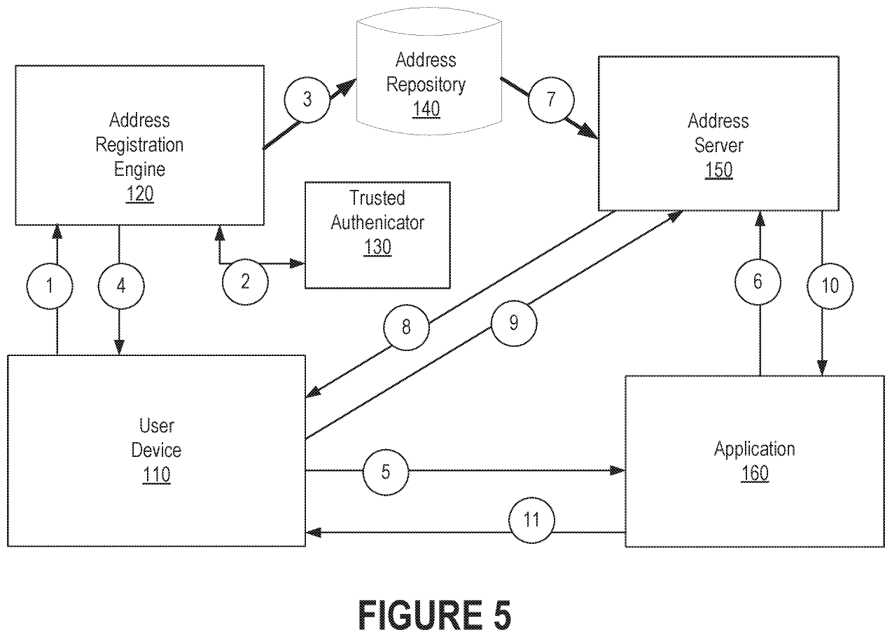

In the following example, Kim orders a pizza from a restaurant with which Kim has had no prior contact. The pizza restaurant, Pizzas 'R Us, has never delivered a pizza to Kim before. FIG. 5 is a block diagram showing the ordered interactions among components in the address management system, in accordance with one or more embodiments. The process of Kim having a pizza delivered is explained based on the numbered interactions in FIG. 5.

Kim registers her user code with address registration engine 120 (step 1). She provides the user code (kimcruise01@ denver), mobile phone number, email address, full physical address, and GPS coordinates (latitude and longitude). Kim may also provide a photocopy of her passport and her latest phone bill to demonstrate that the provided address and phone numbers are hers. The registration engine sends the address information and additional documents to trusted address authenticator 130 to verify that the address Kim provided is really Kim's address information (step 2). If Kim's information checks out, then a record is created in address repository 140 that associates Kim's user code with her address information (step 3). Also, once the information is validated, Kim receives notice that her registration has been approved, and her user code can now be used (step 4).

Immediately, or at some later time, for example, several weeks or months after Kim's user code is registered, Kim decides to order a pizza online from a new pizza place, Pizzas 'R Us. When prompted for her delivery address, Kim enters her user code as: kimcruise01@ denver instead of entering her physical delivery address (step 5). Application 160 that accepts pizza orders for Pizzas 'R Us receives Kim's order and requests the delivery address from address server 150 (step 6). The application sends a request to the address server to receive the full physical address and phone number (in case there is a question about Kim's order) corresponding to kimcruise01@ denver. The address server looks up Kim's physical address based on the user code kimcruise01@ denver and retrieves the physical address from the repository (step 7).

In step 8, Kim Cruise receives a request from the address server for Kim to authorize sharing her physical address and phone number with Pizzas 'R Us for delivering a pizza. Kim authorizes the release of the information (step 9), and the address server sends the delivery address including GPS coordinates and phone number to Pizzas 'R Us (step 10). Pizzas 'R Us uses the exact map co-ordinates from the physical address to easily find the place to deliver Kim's pizza (step 11).

### 5. USING DISTRIBUTED LEDGER TECHNOLOGY

A distributed ledger (also called a shared ledger, or distributed ledger technology, DLT) is a consensus of replicated, shared, and synchronized digital data geographically spread across multiple sites, countries, or institutions. There is no central administrator or centralized data storage. A peer-to-peer network and consensus algorithms are used to ensure replication across nodes is undertaken. One form of distributed ledger design is the blockchain system.

A blockchain is a growing list of records, called blocks, which are linked using cryptography. Each block contains a cryptographic hash of the previous block, a timestamp, and transaction data. By design, a blockchain is resistant to modification of the data because the blockchain can record transactions among parties efficiently and permanently in a way that is verifiable. For use as a distributed ledger, peers in the peer-to-peer network validate data blocks using decentralized consensus. Once recorded, the data in any given block cannot be altered retroactively without alteration of all subsequent blocks, which requires consensus of the network majority. Hyperledger is one of a number of frameworks for building distributed ledgers and is used as an example to describe how the invention could be implemented with distributed ledger technology? For example, components under the hyperledger umbrella include identity and permission management and blockchain managers.

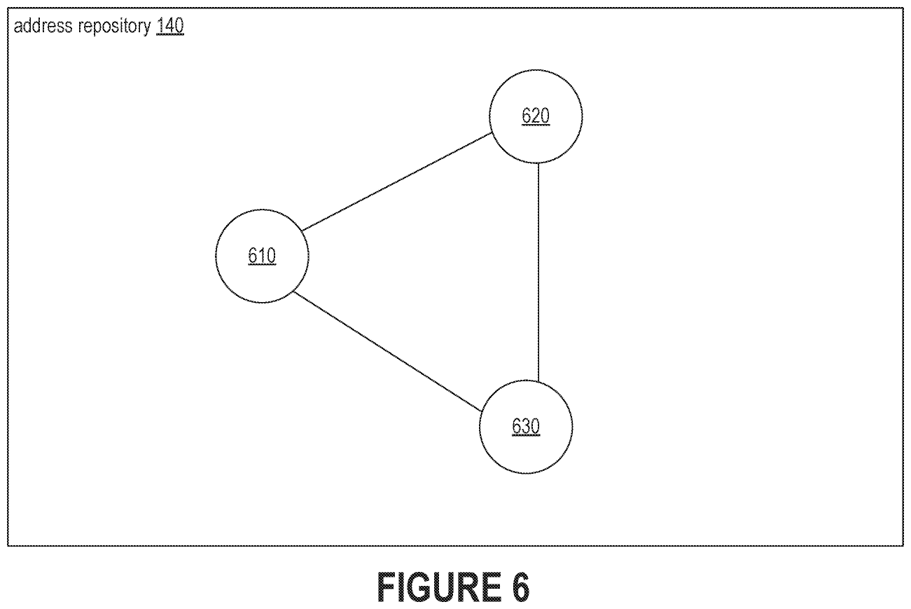

FIG. 6 is a block diagram that illustrates an address repository implemented as a peer-to-peer distributed ledger network, in accordance with one or more embodiments. In this example, the address repository 140 is implemented as a network of three peers: 610, 620, and 630. In an embodiment, each peer maintains a replica of the state database and corresponding ledger. The state database stores the address information in association with a user code, and the ledger, which may be implemented by a blockchain, records the transactions applied to the state database (similar in semantics to a transaction log file). Each peer in the network may independently receive transaction requests, fulfill the request, and pass the transaction and state change to the other peers in the network.

The address registration engine and the address server may each be assigned an identity known to the distributed ledger network. Each identity may be associated with an appropriate level of access to the data stored in the repository. For example, in one embodiment, the identity for the address registration engine may be associated with the authorization to create new user code/address associations in the repository or to modify an existing association already in the repository. In an embodiment, the identity for the address server may be associated with authorization to read information stored in the repository.

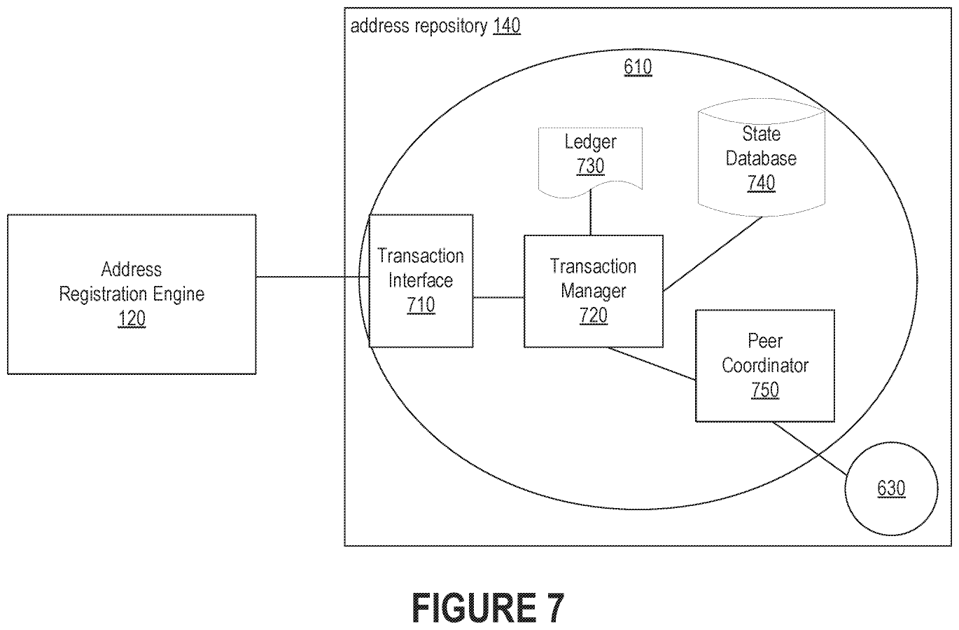

FIG. 7 is a block diagram that illustrates an address registration engine interacting with one of the peers of a peer-to-peer distributed ledger network, in accordance with one or more embodiments. A person of skill in the art will understand that there are many ways for selecting one peer of a set of identical peers. Any one of the peers may be selected to receive a request based on, for example, physical proximity, current load, round robin, or at random. In the example of FIG. 7, address registration engine interacts with peer 610 of the address repository 140. The address registration engine may send a new user code/address association to peer 610 with a request to create a new association in the database.

Transaction interface 710 may receive transactions relevant to the address management system. Using the word “asset” as a short hand for a user code/address association in the repository, examples of transactions may include create asset, modify asset, delete asset, and read asset. Thus, the address registration engine sends a create asset request to the transaction interface 710. Transaction Interface 710 receives the transaction request and provides the transaction to transaction manager 720. To process a create asset transaction, transaction manager 720 writes a transaction into ledger 730 such as (create kimcruise01@ denver). Ledger 730 may be a blockchain. Transaction manager 720 may also write a new record for kimcruise01@ denver into State Database 740. Peer coordinator 750 may send the newly created transaction to the other peers. In an embodiment, the new database record may also be sent to peers in the network. In an embodiment, each peer receiving the transaction may apply the transaction to create a new record in their local state database. When done, each peer may have a ledger and a state database having the same content that includes the new user code and address.

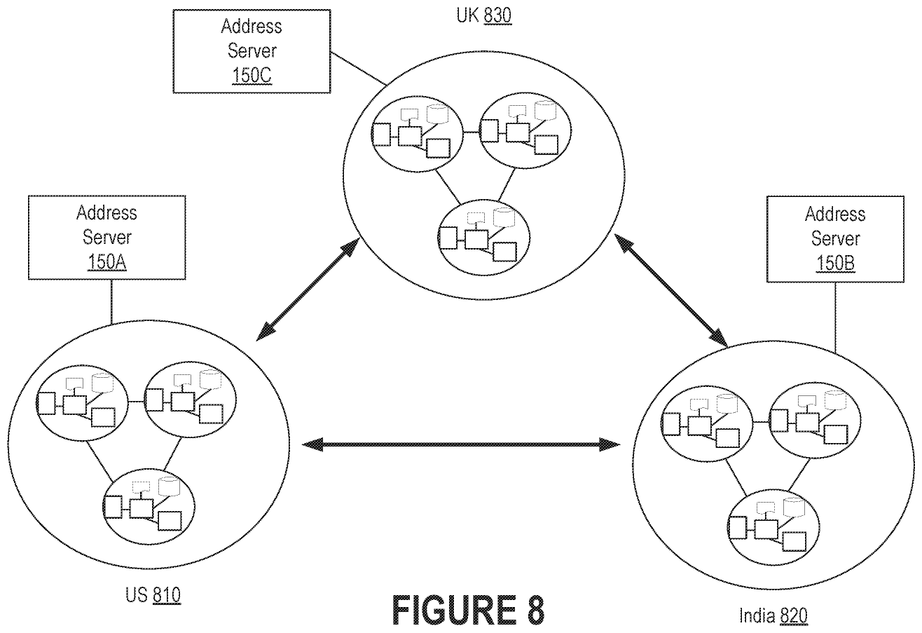

In the context of an address management system, the distributed ledger network may have a particular geographic scope. FIG. 8 illustrates cooperating distributed ledger networks, in accordance with one or more embodiments. FIG. 8 illustrates a global ledger network comprising a US distributed ledger network 810, an Indian distributed ledger network 820, and a UK distributed ledger network 830. For example, a US network 810 may manage physical addresses located in the United States, and all peers in the US network may maintain a ledger and database for only US physical addresses. All the peers participating in the India network 820 may maintain a ledger and database for only Indian physical addresses. Likewise, the UK network 830 may maintain a ledger and database for managing only British addresses.

In an embodiment, the distributed ledger network itself may include the capability to communicate among independent distributed ledger networks to provide a global distributed network. For example, a company in the US may need the physical address of a user code for a user located in India. The application for the company may send, to address server 150A in the US, the user code with a request to receive the corresponding physical address. Address server 150A in the US may send a read asset transaction to a local peer of the US network 810, requesting the Indian physical address. In a global distributed network, the peer in the US network 810 may forward the request to a peer in the Indian network 820. If the Indian user, who provided the Indian network 820 with the desired user code, grants permission, the peer in the Indian network 820 may retrieve the desired physical address and send the physical address to the requesting peer in the US network 810. The peer in the US network may relay the physical address back to address server 150A. Address server 150A may then provide the Indian address to the requesting US company's application.

Inter-ledger network cooperation may require that peers in one ledger network have identities known to other ledger networks and be associated with necessary authorization. For example, peers in the US network 810 may have identities known to the India network 820 and UK network 830 with associated read only access.

In an embodiment, each distributed ledger may be independent of one another having no inter-ledger contact or cooperation. In an embodiment, each address server may be known to an associated local ledger network. For example, address server 150A may have an identity known to the US network 810; address server 150B may have an identity known to the Indian network 820; and address server 150C may have an identity known to the UK network 830. The identity of address server 150A may also be known address server 150B and vice versa. An application for a US company wanting to retrieve an Indian physical address may send, to address server 150A, the Indian user code with a request to retrieve the corresponding physical address. Address server 150A may forward the request to its trusted counterpart, address server 150B. Address server 150B may retrieve the physical address information from the Indian ledger network 820 and forward the physical address back to address server 150A. In turn, address server 150A may send the Indian physical address information to the requesting US company's application.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is labeled with a tenant ID. A tenant is permitted access to a particular network resource only if the tenant and the particular network resources are associated with a same tenant ID.

In an embodiment, each tenant is associated with a tenant ID. Each application, implemented by the computer network, is labeled with a tenant ID. Additionally or alternatively, each data structure and/or dataset, stored by the computer network, is labeled with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be labeled with a tenant ID. Only a tenant associated with the corresponding tenant ID may access data of a particular database. As another example, each entry in a database implemented by a multi-tenant computer network may be labeled with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

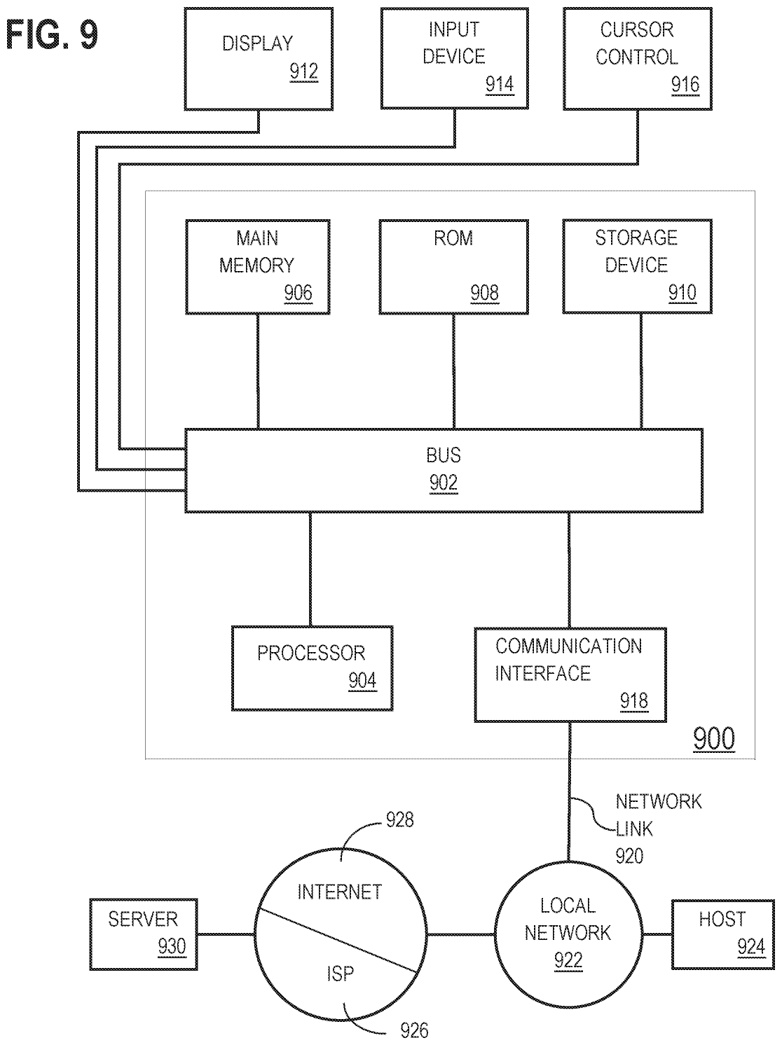

For example, FIG. 9 is a block diagram that illustrates a computer system 900 upon which an embodiment of the invention may be implemented. Computer system 900 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including 121 alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet 123 example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
receiving a request to store a user code in association with an address for an end user, the request including at least the address;
verifying the address for the end user;
responsive to verifying the address, generating a first record associating the address with the user code corresponding to the end user;
storing the first record in a distributed blockchain ledger;
receiving, from an application, a request for address information for the end user, wherein the address information is at least a portion of the address, the request including the user code;
retrieving from the distributed blockchain ledger, based on the user code, address information for the end user;
determining that the application is authorized to access the requested address information for the end user;
returning, to the application, the requested address information for the end user.

2. The method of claim 1, wherein determining that the application is authorized to access the requested address information for the end user comprises determining that the application is authorized to access the entire address, and wherein returning the address information comprises returning the entire address.

3. The method of claim 1, wherein the method is performed by an address server, and the application is an entity known to and trusted by the address server.

4. The method of claim 1, wherein:
the request, received from the application for address information for the end user, further comprises authorization information; and
the method further comprising authorizing the request based on the authorization information.

5. The method of claim 1, wherein determining that the application is authorized to access the requested address information for the end user comprises:
sending a message to the end user; and
receiving a response from the end user indicating that the application is authorized to access the requested address information for the end user.

6. The method of claim 5, wherein:
the response from the end user further indicates a particular portion of the address that the application is authorized to access;
wherein the particular portion of the address is less than the requested address information; and
the portion of the address returned to the application comprises the particular portion of the address.

7. The method of claim 1, wherein verifying the end user's address comprises receiving validation from at least of one: a government agency, a credit bureau, and a telephone directory.

8. The method of claim 1, wherein receiving the end user's address further comprises receiving a copy of authenticating documents including a copy of at least one of:
printed identification issued by a government agency; and
correspondence sent to the end user's address by a well-known entity and delivered to the end user's address by a well-known delivery service.

9. The method of claim 1, wherein:
receiving and verifying the end user's address is performed by a registration engine;
(a) receiving the request from the application, (b) retrieving the address information from the blockchain ledger, (c) determining that the application is authorized to access at least a portion of the end user's address, and (d) returning the address to the application are performed by an address server;
the request to store the user code in association with the end user's address further includes a copy of authenticating documents including at least one of:
printed identification issued by a government agency; and
correspondence sent to the end user's address by a well-known entity and delivered to the end user's address by a well-known delivery service;
verifying the end user's address comprises receiving validation from at least of one: a government agency, a credit bureau, and a telephone directory; and
the method further comprising:
receiving, by the application that provides a user service, a request from the end user to create an account, wherein the request from the end user includes the user code that represents address information for the end user;
creating the account for the end user, by the application, and storing the user code in association with the account;
receiving, by the application, a first request from the end user for service that requires the address information to fulfill;
sending, by the application, a request to the address server for address information for the end user, the request including the user code;
sending, by the address server, a message to the end user requesting authorization to release at least a portion of the end user's address information to the application;
receiving, by the address server, a response from the end user indicating a particular portion of the address that the application is authorized to access, wherein the particular portion of the address that the application is authorized to access is less than the entire address;
receiving, by the application from the address server, the particular portion of the address information authorized by the end user, wherein the particular portion of the address information is a portion of a first address;
providing the service requested by the end user in the first request based on the particular portion of the address information received from the address server;
receiving, by the application from the end user, a second request for service that requires address information to fulfill;
sending a second request for address information for the end user, the request including the same user code that was included with the first request for service;
receiving, by the application from the address server, second address information for the end user that is a portion of a second address that is different from the first address; and
satisfying the second request for service received from the user based on the second address information received from the address server.

10. The method of claim 9, the method further comprising:
receiving, by the address server from the application, a verification request comprising the user code and address information to be verified corresponding to the end user, wherein the address information to be verified comprises at least one of: a street address, a phone number, a unique identifier issued by a government agency, and an email address.;
retrieving, by the address server, the end user's address from the first record of the distributed blockchain ledger, based on the user code;
verifying, by the address server, that the address information to be verified is consistent with the address stored in association with the first record; and
returning, to the application, a confirmation message indicating that the address information to be verified has been successfully verified for the end user.

11. A method comprising:
receiving an address for an end user;
verifying the end user's address;
responsive to verifying the address, generating a first record associating the address with a user code corresponding to the end user;
storing the first record in a distributed blockchain ledger;
receiving, from an application, a verification request comprising the user code and at least a portion of the address corresponding to the end user;
retrieving from the first record of the distributed blockchain ledger, based on the particular user code, at least the portion of the end user's address;
verifying that at least the portion of the address corresponding to the end user is consistent with the address stored in association with the first record; and
returning, to the application, a confirmation message indicating that at least the portion of the address corresponding to the end user is verified.

12. The method of claim 11, wherein at least the portion of the address included in the verification request comprises at least one of: a street address, a phone number, a unique identifier issued by a government agency, and an email address.

13. A method comprising:
receiving a request comprising user input submitted via an address field;
determining whether the user input corresponds to code in a supported code format;
responsive to determining that the user input corresponds to the code in the supported code format:
querying a with the user input to retrieve an address corresponding to the code;
and
processing the request based on the address corresponding to the code;
responsive to determining that the user input does not correspond to any code in the supported code format, processing the request based on an address recited in the user input.

14. A method comprising:
receiving from a user a request to create an account with an application providing a user service, wherein the request from the user includes a user code that represents address information for the user;
creating an account for the user and storing the user code in association with the account;
receiving from the user a request for service that requires address information to fulfill;
sending a request to an address server for address information for the user, the request including the user code;
receiving the address information for the user from the address server; and
satisfying the request for service received from the user based on the address information received from the address server.

15. The method of claim 14, wherein:
the request for service is a first request for service, and the address information for the user received from the address server is first address information; and the operations further comprising:
receiving from the user a second request for service that requires address information to fulfill;
sending to the address server a second request for address information for the user, the request including the same user code that was included with the first request for service;
receiving second address information for the user from the address server, wherein the first address information is different from the second address information; and
satisfying the second request for service received from the user based on the second address information received from the address server.
